(19) United States
(12) Patent Application Publication
(10) Pub. No.: US 2026/0155268 A1
(43) Pub. Date: Jun. 4, 2026

(54) POLYMER-BASED AQUEOUS HOMOGENEOUS REACTOR

(71) Applicant: CAL THERMO, LLC, The Woodlands, TX (US)

(72) Inventors: Stephen A. Boyd, The Woodlands, TX (US); Garrett Edward Kinsman, San Francisco, CA (US)

(73) Assignee: CAL THERMO, LLC, The Woodlands, TX (US)

(21) Appl. No.: 19/406,813

(22) Filed: Dec. 2, 2025

Related U.S. Application Data
(60) Provisional application No. 63/727,174, filed on Dec. 2, 2024.

(51) Int. Cl. G21C 13/08; G21C 17/00; G21C 21/00

(52) U.S. Cl. CPC G21C 13/08; G21C 17/00; G21C 21/00

(57) ABSTRACT

A nuclear reactor may be created using a polymer. A nuclear reactor may be formed using additive manufacturing. A nuclear reactor may be coupled to other nuclear reactors to form an array of reactors.

### RELATED APPLICATION

This application claims the benefit of U.S. Provisional Application No. 63/727,174, filed Dec. 2, 2024, the disclosure of which is incorporated herein by reference in its entirety.

This disclosure relates to techniques for the design and printing/construction using additive manufacturing (e.g., 3D-printing) techniques for a (fluoro)polymer-based aqueous homogeneous reactor.

### BACKGROUND

Unless otherwise indicated herein, the materials described herein are not prior art to the claims in the present application and are not admitted to be prior art by inclusion in this section.

A reactor may include a device that controls nuclear energy, a device that regulates electrical current, and a container for chemical reactions.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

In some examples, a nuclear reactor may be created using a polymer.

In some examples, a method may include forming a first reactor using additive manufacturing, forming a second reactor using additive manufacturing, and coupling the first reactor to the second reactor to form an array of reactors.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1A illustrates an example reactor.

FIG. 1B illustrates an example reactor.

FIG. 1C illustrates an example reactor.

FIG. 2 illustrates an example reactor.

FIG. 3 illustrates an example reactor.

FIG. 4A illustrates an example removable sphere head.

FIG. 4B illustrates an example removable sphere head.

FIG. 5A illustrates an example removable sphere head.

FIG. 5B illustrates an example removable sphere head.

FIG. 5C illustrates an example sleeve clearance calculation.

FIG. 6A illustrates example mixing blades with other components.

FIG. 6B illustrates example assembly including mixing blades.

FIG. 7A illustrates an example circuit.

FIG. 7B illustrates an example circuit.

FIG. 8A illustrates an example cooling coil.

FIG. 8B illustrates an example condensation coil.

FIG. 9 illustrates an example removable sphere head.

FIG. 10 illustrates an example process flow for a reactor.

FIG. 11 illustrates an array of reactors.

### DETAILED DESCRIPTION

In the early decades of this 21st century, the world has seen a truly global resurgence in nuclear energy. The advent of so-called Generation-IV nuclear technologies, many of which are being developed now, has risen to the fore. Billions of dollars have already been exchanged and a wide variety of nuclear designs are in varying stages of development.

One unusual design that appears to have been ignored is the Aqueous Homogeneous Reactor (AHR). Rather than relying on the classic, dense uranium dioxide/triuranium octoxide (²³⁵UO₂/^{235/238}U₃O₈) pellet encased in a Zircaloy cladding found in all civilian nuclear fuel assemblies, the AHR presents an aqueous fuel. First licensed and sold in the 1950s in Southern California, and then globally soon after, the AHR was less of an answer to global energy crises and more of a thermally self-limited anomaly. With an aqueous fuel acting as both solvent and neutron moderator, the AHR produces electricity through conventional heat exchange, as well as copious amounts of hydrogen. This is due to the water being radiolytically split during the neutron-moderating event.

The AHR is metals-agnostic; it can use any fissile isotope or mixtures therein. Originally, it used a high-molarity, moderately ²³⁵U-enriched saline fuel of uranyl dinitrate hexahydrate (²³⁵UO₂(NO₃)₂·6H₂O) or its sulfate-salt equivalent. As mentioned above, upon initialization of

the nuclear chain reaction, the AHR's design makes use of its aqueous solvent, whereby the water, being predominantly comprised of protium (hydrogen) is acting as both solvent and neutron moderator. As such, no graphite or other solid-state neutron moderator is necessary. Fission then engenders the propagation of the wide and well-known variety of fission products (FPs) that normally results from fission events. With an acidic (pH≥3), aqueous environment, however, the resultant FPs are easily, instantly dissolved as nitrate salts. The only requirements for uninterrupted, continuous operations are a steady stream of ultra-pure water and small amounts of nitric (or sulfuric) acid.

Historically, the AHR was run at-pressure and at elevated temperatures. This was intended to maximize the output of the system. Because of these elevated energies, the AHR needed robust containment that was also chemically resistant to the aggressive aqueous-nitrate environment. Finally, the containment metal simultaneously, ideally, would have as low a neutronic cross section as possible. Previous versions of the AHR used zircaloy. An expensive alloy, zircaloy is, in the short term, resistant to aqueous nitric acid, but does oxidize to ZrO₂. This is usually due to the oxidizing assistance of in-situ, high-valence metals that naturally result from FP production during normal fission events such as Cr⁶⁺ and Mo⁶⁺. The resultant Zr(IV) oxide (ZrO₂) is then obviously susceptible to further attack, given that the dominant, low-temperature crystallographic phase displays such low symmetry: monoclinic (P2₁/c). It eventually, slowly fully nitrates to the nitrate pentahydrate: Zr(NO₃)₄·5H₂O.

A more modest, low-temperature (88°≤T≤103° C.) version of the AHR is feasible and in fact mass-producible, so long as aggressive thermal, neutronic, FP, ionizing-radiation and gas understanding and management is practiced. Accompanying these more moderate temperatures, while managing the aforementioned phenomena begs the question: is there a superior containment material for an aqueous homogeneous nuclear reactor?

By way of example, some embodiments are described in the context of a nuclear reactor, but techniques used herein can also be used for other types of reactors, such as chemical reactors (for example jacketed chemical reactors, Continuous Stirred Tank Reactor, micro reactors, Packed-Bed Reactors, Plug Flow Reactors).

### Four Parameters: Neutronics, Temperature, Chemical Resistance/pH, Ionizing Radiation

Polymers and fluoropolymers were in their infancy at the time the AHR was licensed and sold. Although quite non-intuitive, after several decades of intense investigation, modern polymer understanding is now mature. Their molecular, microscopic, mesoscopic, intermolecular and localized crystalline structures are well-understood. In particular, their robust performance under punishing conditions of high neutron and gamma fluxes has been found to be exceptional.

Certain specific polymers and fluoropolymers satisfy the parameters outlined above: pH/chemical resistance, temperature, ionizing radiation, neutronics. They accomplish this nonintuitively, however.

The present disclosure provides using additive manufacturing, including fused deposition modeling “FDM” or “filament based 3D printing” to achieve the rapid design an assembly of AHRs.

### Neutronics

Polymers and fluoropolymers are inherently low-density materials. They typically range from denser polymers such as PTFE (ρ=2.2 g/cm³) to a low of ˜0.9 g/cm³ for polypropylene (PP) and polyethylene (PE).

Generally, polymers owe their low densities to three factors: low-molar mass elemental composition, spatially large, amorphous subregions and large crystallographic unit cells for their local, quasi-periodic crystalline subdomains. These three aspects contribute to excellent neutronic invisibility and extremely low embrittlement.

Polymers are usually comprised of very few, low-molar mass elements. Those elements are often monoisotopic. For example, only carbon and hydrogen comprise PP in a simple CₓH₂ₓ ratio. Carbon's dominant isotope for example, ¹²C, represents >98.8% of total natural abundance on earth. Its neutronic cross section is near zero. Hydrogen on earth is comprised of >99.9% protium, dwarfing its second-most abundant, naturally occurring and non-radioactive istotope, deuterium.

### Temperature

Polymers owe their surprisingly high melting points to three main features: their unusually long polymeric lengths, their tacticity and their amorpho-periodic ratios. Polymer lengths can range as high as 100,000 monomeric units. Although their side chains (such as methyl groups in PP) are mostly non-polar, such extraordinary lengths dramatically increase the total intermolecular forces such as van der Waal's forces. This is one major contributor to their higher melting points. Tacticity, or the relative periodicity of adjacent, stereochemical, side-chain group repetition motifs, contributes to higher melting points as well. Finally, the frequency of crystalline subdomains and the amorphoperiodic ratios contained therein also contribute to elevated melting points. Polymers exhibit quasi-periodic, localized sub-domains of crystallinity, flanked by adjacent sub-domains of amorphicity. Generally, the lower the of amorphoperiodic ratio of subdomains (so, more crystalline subdomains than amorphous ones), the higher the melting point.

### Chemical Resistance/pH

Polymers exhibit a wide range of chemical resistance/pH robustness. This is due to the molecular classes of side chains as well as their overall crystallinity. Polar side chains or backbones comprised of electron-rich moieties such as sulfonates, sulfide-bridges, nitriles, acrylonitriles, lactates are all susceptible to Brønsted and Lewis attack. Nonpolar polymers such as PP, PE or fluoropolymers exhibit near complete chemical resistance and do not suffer under dramatic swings in pH. In addition to their nonpolarity, their crystalline subdomains contribute to their chemical resistance.

3D printed heat exchanger in the wall of the reactor: Use of custom 3D printed shapes that allow working fluid (e.g. water, ammonia, CO₂) to run through the wall of the reactor for cooling. Use of multi-component materials, e.g. filament impregnated with metals or metal-metalloid binary, ternary or n-ary compounds to increase thermal conductivity, and optimize intramural chemistry, facilitating intramural catalysis are introduced here (e.g., outer surfaces touching fluid to be a fuel resistant polymer, while chemosynthesis occurs within the wall boundaries, due to simultaneous heat and subatomic-particle exposure). Impregnating thermal and/or thermocatalytic materials may include metals (like copper, gold, or other materials like boron arsenide (using boron 11), carbon, diamond, zinc, palladium, tosyl chloride, triflic acid, etc.).

### Ionizing Radiation

Of the three types of ionizing radiation, alpha, beta and gamma, only gamma appears to weakly interact with polymers and fluoropolymers. Along with neutron flux, decades of research have demonstrated that extended periods of high neutron and gamma flux actually slowly increase polymeric, fluoropolymeric crystallinity, as well as tensile strength. These have been determined to be due to cross linking polymers. The long-term effects therefore improve (fluoro)polymer performance.

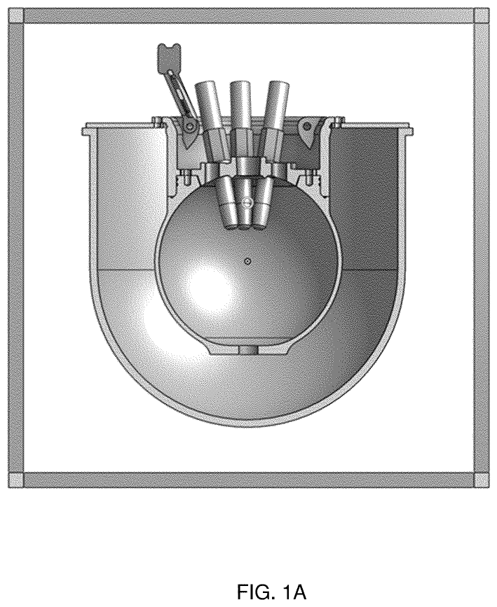

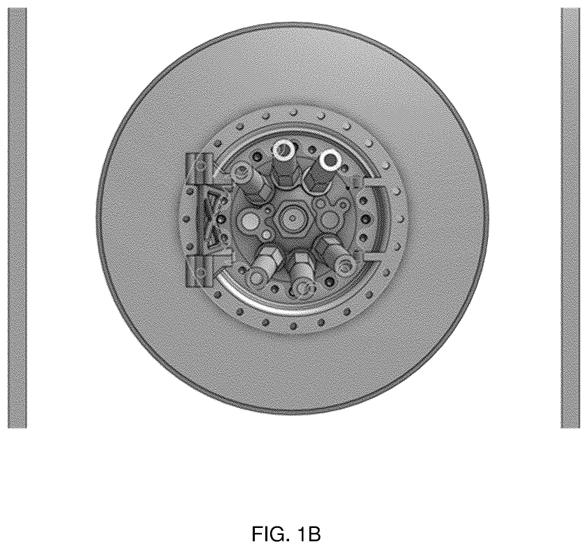

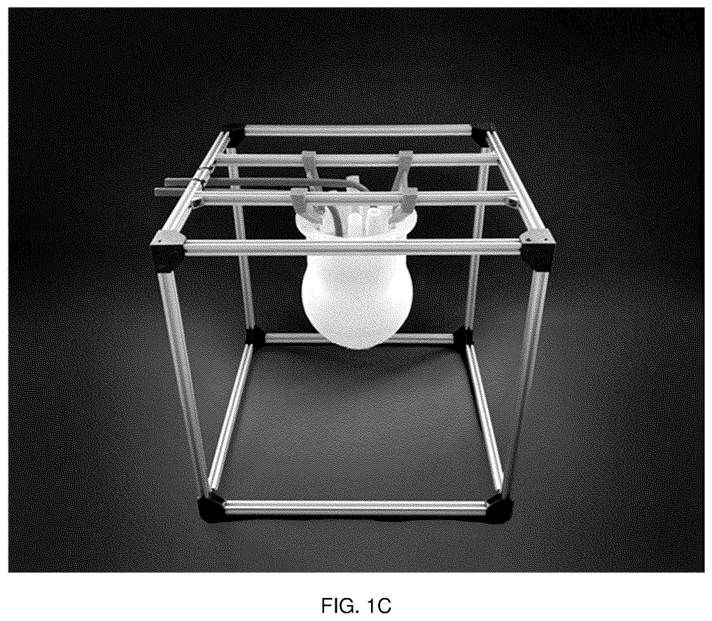

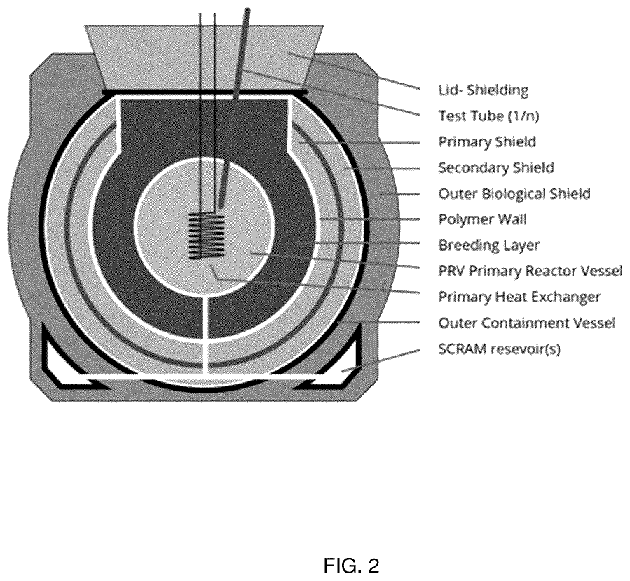

As illustrated in FIGS. 1A-1C and FIG. 2, a reactor may include various components such as a lid-shielding, one or more test tubes; a primary shield, a secondary shield, an outer biological shield, a polymer wall, a breeding layer, a PRV primary reactor vessel, a primary heat exchanger, an outer containment vessel, or SCRAM reservoirs.

The primary shielding is mercury-196 (¹⁹⁶Hg), the secondary shielding is lead-mercury amalgam and the tertiary shielding is depleted uranium (DU), viz., ˜99% pure ²³⁸U isotope. The outer biological shielding may be impregnated polymer or more likely high melanin fungus substrate. In some embodiments, the outer containment vessel may be made from any grade of acid-resistant stainless steel, such as 304, 316 or 316-L stainless steel.

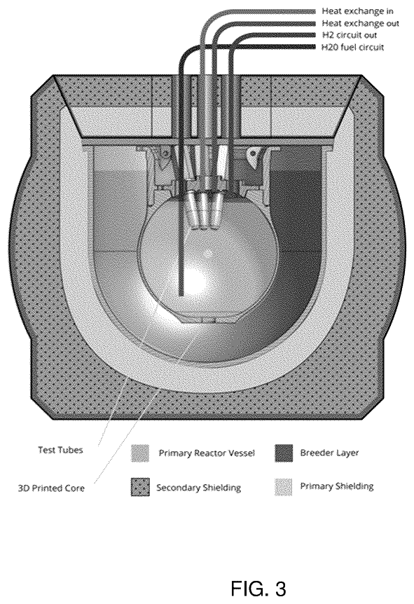

As illustrated in FIG. 3, a reactor may include a primary reactor vessel, a breeder layer, a secondary shielding, a primary shielding, one or more test tubes, and a 3D printed core. Heat exchange may occur in which heat exchange is inserted into the primary reactor vessel or heat exchanged is output from the primary reactor vessel. An H₂O fuel circuit may carry H₂O fuel into the circuit and output H₂.

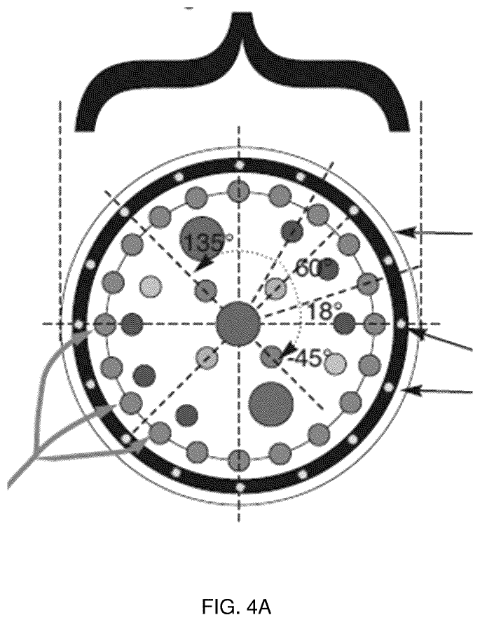

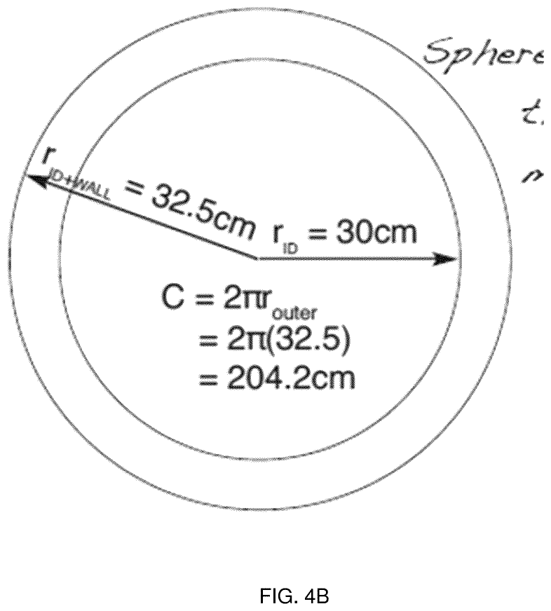

FIG. 4A illustrates an example removable sphere head. The removable sphere head may have a head arc length of 55° or 31.18 cm. The head threading may be a standard threading for a diameter of a curved object. The handle (depicted in black) may include 16 radially, circumferentially equidistant ¼″ 20 by 2 cm (deep) tapped holes (e.g., as shown by yellow dots). The green dots may be two 1.25″ NPT-tapped holes which may be used for outgassing. The orange dots may be two ½″ NPT-tapped holes which may be PTFE plugs. The red dots may be 34/45 tapered holes e.g., stirrer/bearing. The brown dots may be twenty 2.17 cm (NPT-tapped) holes that may be e.g., 18° apart. The brown dots may accommodate an equal number of Sch-40 NPT-tapped 12 cm-long (IL), 2.1 cm (ID) ECTFE sleeves. The sleeves may be screwed in from below. The holes may be normal to the surface. The magenta dots may be six ½″ inch NPT-tapped holes which may be 60°apart and may accommodate female-female extension nipples. The blue dots may be two ½″ NPT-tapped holes which may be bulkhead threaded e.g., cooling coil.

FIG. 4B illustrates an example removable sphere head. The sphere may have various inner and outer dimensions. For example, the radius may be 32.5 cm when the wall is included or 30 cm when the wall is not included. The circumference (e.g., 2*pi*r) may be 204.2 cm when the wall included. The wall for the sphere head may have a thickness of about 2.5 cm and may be formed of the material ethylene-chlorotrifluoroethylene (ECTFE).

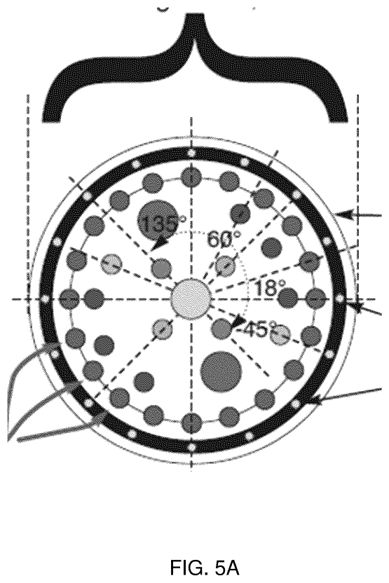

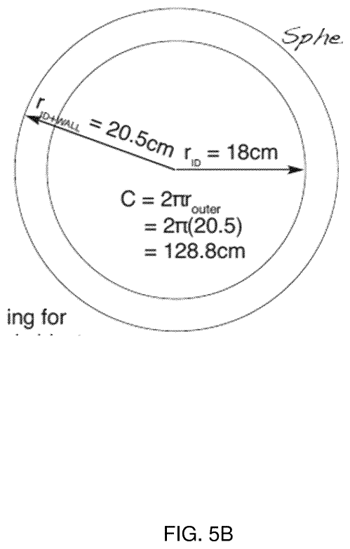

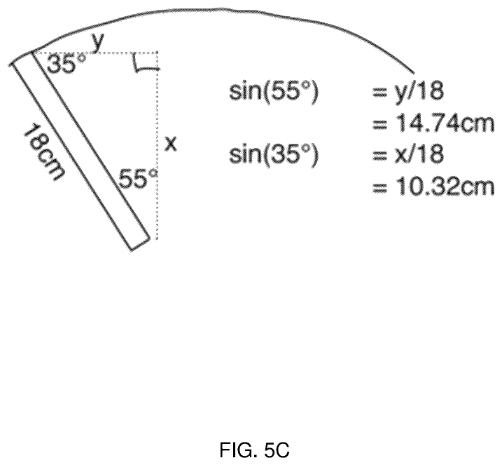

FIG. 5A illustrates an example removable sphere head. The removable sphere head may have a head arc length of 70° or 25.04 cm. The head threading may be a standard threading for a diameter of a curved object. The handle (depicted in black) may include 16 radially, circumferentially equidistant ¼″-20 by 2 cm (deep) tapped holes (e.g., as shown by yellow dots). The green dots may be two 1 ″ NPT-tapped holes which may be used for outgassing. The orange dots may be two ½″ NPT-tapped holes which may be PTFE plugs. The light green dots may be two ½″ NPT-tapped holes which may be pH sensors. The pink dots may be 24/40 tapered holes e.g., stirrer/bearing. The indigo dots may be twenty 1.x cm (NPT-tapped) holes that may be e.g., 18° apart. The indigo dots may accommodate an equal number of Sch-40 NPT-tapped 18 cm-long (IL), 1.1 cm (ID) ECTFE sleeves. The sleeves may be screwed in from below. The holes may be normal to the surface. The magenta dots may be six ½″ inch NPT-tapped holes which may be 60° apart and may accommodate female-female extension nipples. The blue dots may be two ½″ NPT-tapped holes which may be bulkhead threaded e.g., cooling coil.

FIG. 5B illustrates an example removable sphere head. The radius of the sphere head may be 20.5 cm when the wall is included and 18 cm when the wall is not included. The circumference (e.g., 2*pi*r) may be 128.8 cm when the wall is included. The wall may have a thickness of 2.5 cm and may be formed of the material ECTFE.

FIG. 5C illustrates an example sleeve clearance calculation. The value of y may be obtained by sin (55°) and the value of x may be obtained as sin (35°) as shown in the example.

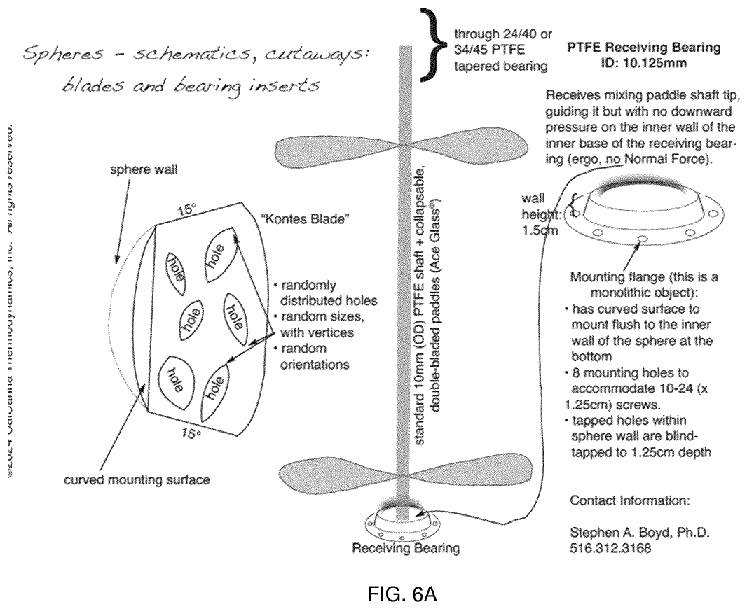

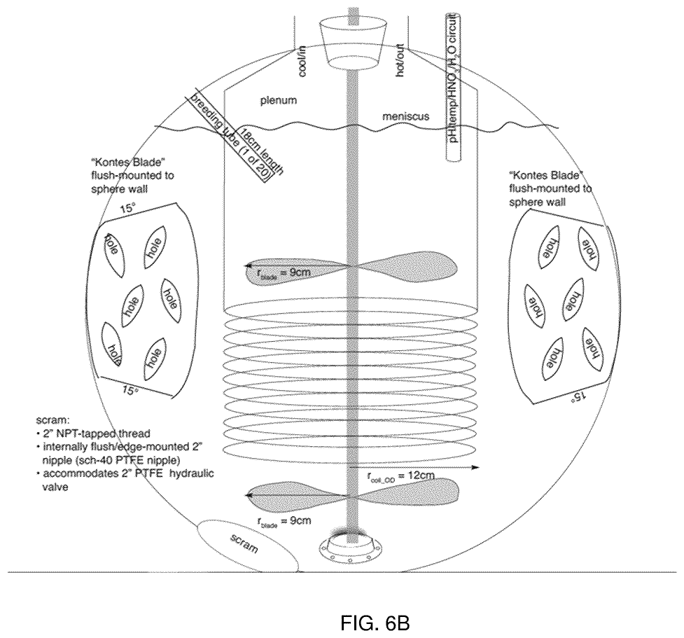

FIG. 6A illustrates example mixing blades with other components. The mixing blades may be 24/40 or 34/45 PTFE tapered bearing. The mixing blades may be e.g., 10 mm PTFE shaft with a collapsible double-bladed paddle. On the sphere wall, there may be a curved mounting surface which may include various holes of different configurations. The randomly distributed holes may have random sizes and vertices and may have random orientations.

A PTFE receiving bearing may be coupled to the mixing blades. The PTFE receiving bearing may receive mixing paddle shaft tip guiding it without downward pressure on the inner wall of the inner base of the receiving bearing e.g., without normal force. The wall height for the receiving bearing may be 1.5 cm. The receiving bearing may have a mounting flange which may be a monolithic object. The receiving bearing may have a curved surface to mount flush to the inner wall of the sphere at the bottom. The receiving bearing may have 8 mounting holes to accommodate 10-24 (x 1.25 cm) screws. The tapped holes within sphere wall may be blind-tapped to 1.25 cm depth.

FIG. 6B illustrates example assembly including mixing blades. The mixing blades may be coupled to the receiving bearing. The sphere hall may have holes that may be randomly arranged. The scram may be 2″ NPT-tapped thread which may be internally flush/edge mounted 2″ nipple (sch-40 PTFE nipple) which may accommodate 2″ PTFE hydraulic valves. Breeding tubes (e.g., 18 cm in length) may be past the meniscus. A pH/HNO₃/H₂O circuit may be coupled to the assembly.

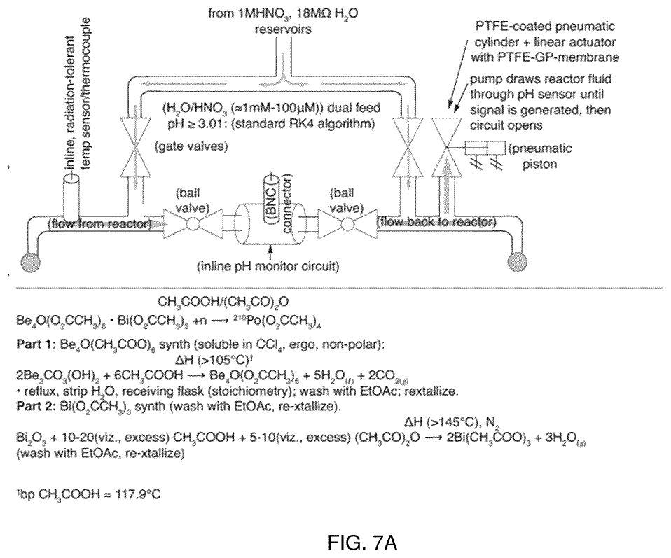

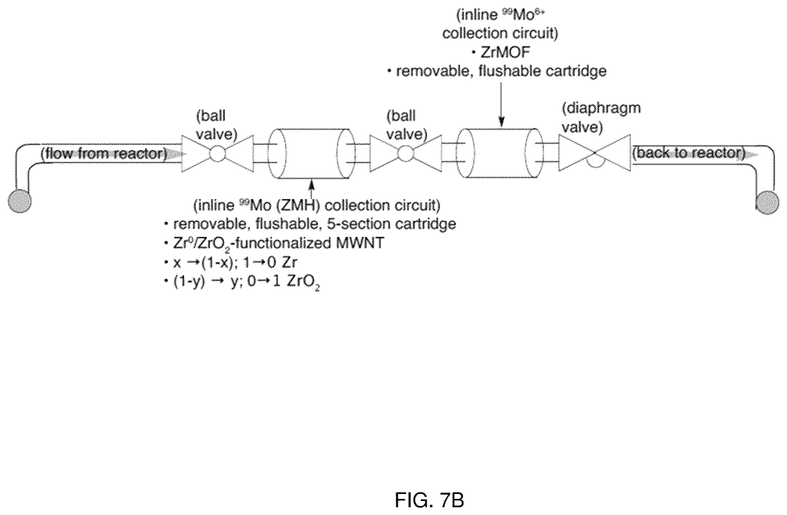

FIG. 7A illustrates an example circuit. The circuit may include flow from a reactor. The flow from the reactor may provide an inline radiation-tolerant temperature sensor or thermocouple. The flow from the reactor may be coupled to a ball valve which may be coupled to a BNC connector which may be coupled to another ball value. The flow may be directed back to the reactor. As the flow is directed back to the reactor, a PTFE-coating pneumatic cylinder and linear actuator with PTFE-GP-membrane may be coupled. The pump may draw reactor fluid through a pH sensor until a signal is generated and a circuit is opened. The pump may be coupled to a pneumatic piston.

Flow from 1MHNO₃, 18MΩ H₂O reservoirs may be directed past a gate value toward the flow from the reactor and/or to the flow back to the reactor. The flow may be H2O/HNO3 having a concentration of 1 mM to 100 μM. The flow may be a dual feed having a pH of 3.01 using a standard RK4 algorithm. Various chemical equations (as shown) may be used.

FIG. 7B illustrates an example circuit. The flow from the reactor may be directed to a ball value. The ball valve may be coupled to an inline ⁹⁹Mo (ZMH) collection circuit which may be removable, flushable, 5-section cartridge. The collection circuit may be coupled to another ball valve which may be coupled to an inline ⁹⁹Mo⁶⁺ collection circuit which may be a removable and flushable cartridge. This collection circuit may be coupled to a diaphragm valve which may be coupled to flow back to the reactor.

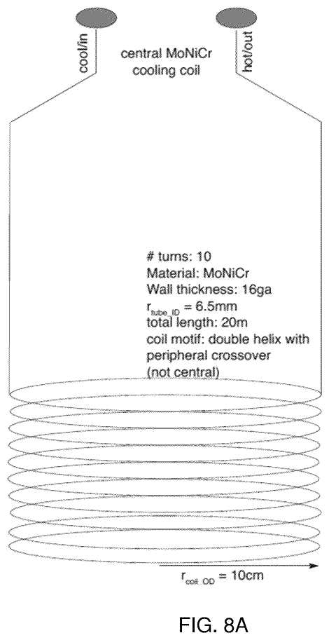

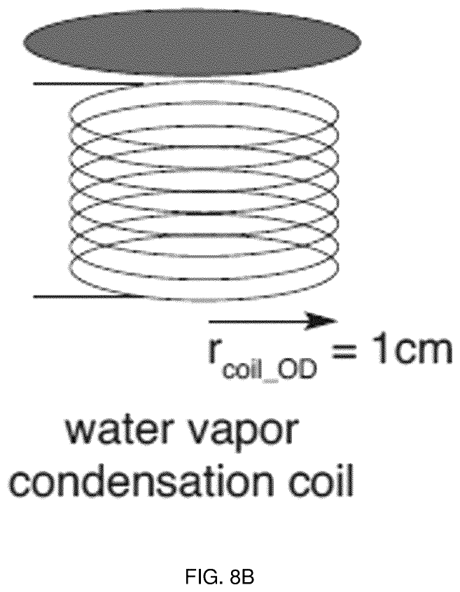

FIG. 8A illustrates an example cooling coil. The cooling coil may be a central MoNiCr cooling coil. The cooling coil may have 10 turns with a wall thickness of 16 ga. The radius may be 6 mm and the total length may be 20 m. The coil motif may be double helix with peripheral crossover (not central). The radius of the coil may be 10 cm.

FIG. 8B illustrates an example condensation coil. The condensation coil may be a water vapor condensation coil. The radius of the coil may be 1 cm. The coil may be within 1.25″ outgassing pipes (through-wall). The coil may be 304-SS standard ¼″ or Al-1100-H14 (Al-alloy) or Inconel-601 (which may be robustly resistant to dilute (e.g., 5-40%) HNO_{3(aq)}. There may be 1″ OD at the turn. The H₂O temperature may be 4° C. There may be a single helix with 8 turns.

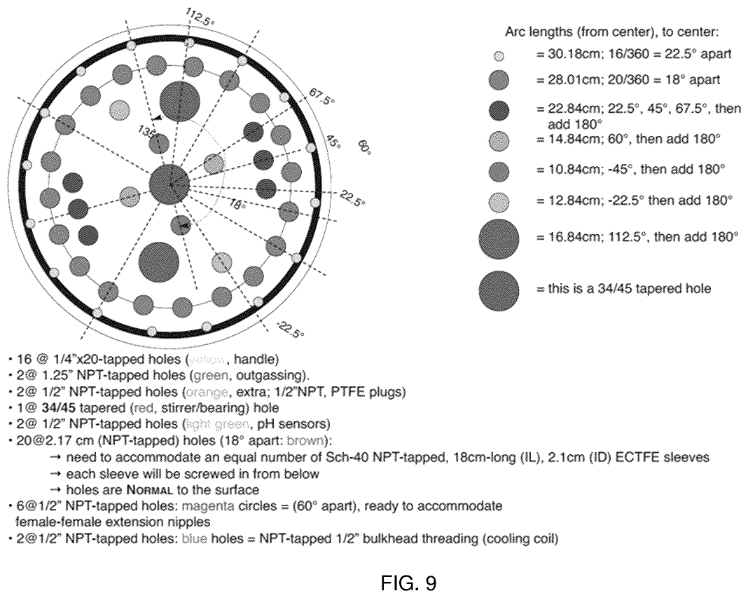

FIG. 9 illustrates an example removable sphere head. The removable sphere head may have the arc lengths and dimensions as shown.

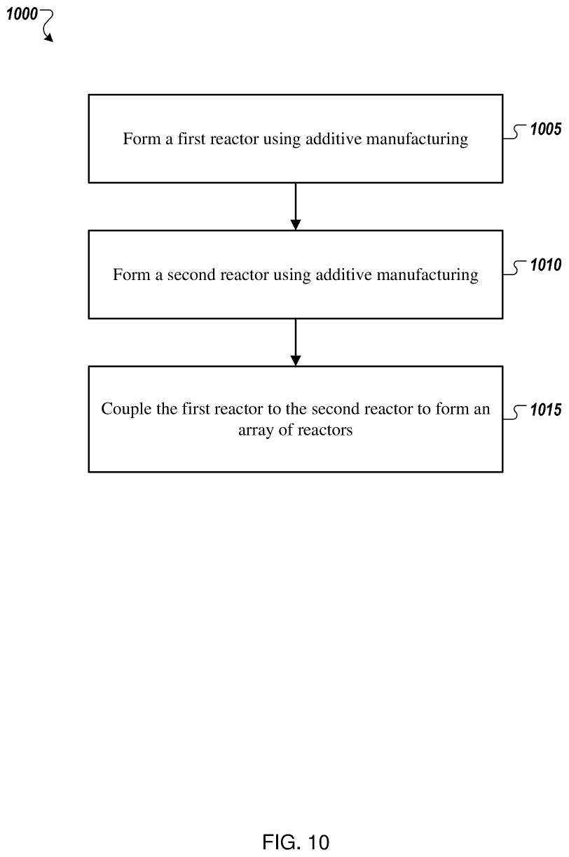

FIG. 10 illustrates an example process flow for a reactor. The method 1000 may begin at operation 1005 and may include forming a first reactor (e.g., a nuclear reactor) using additive manufacturing. The method 1000 may continue at operation 1010 and may include forming a second reactor (e.g., a nuclear reactor) using additive manufacturing. The method may continue at operation 1015 and may include coupling the first reactor to the second reactor to form an array of reactors.

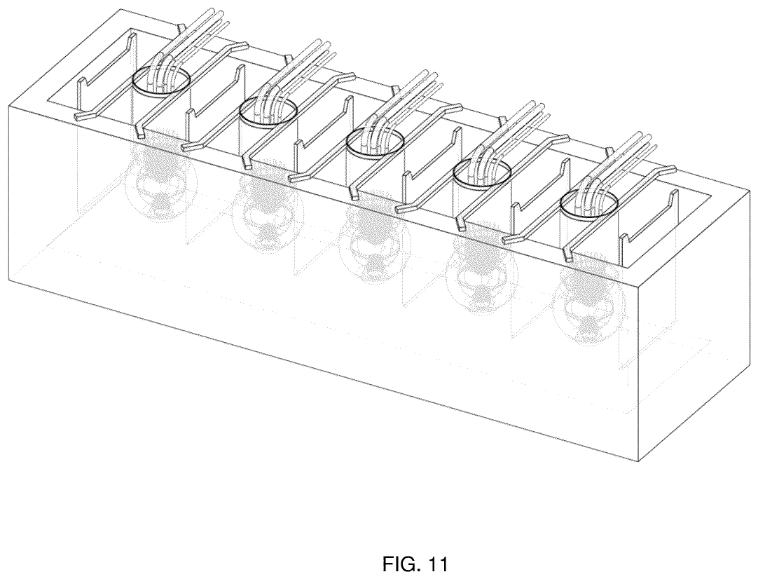

FIG. 11 illustrates an array of reactors. Both the heat and each of the isotopes to be harvested from the liquid fuel can then be treated as vectors, wherein the vector addition may be linear. Physical arrays may be arranged in 1, 2, or 3 dimensions. Their assignment reflects this. For example, in a 1D array, the arrangement is: Σ_i=1−n, M_i;. In 2D, the arrangement is: Σ_i, j=1−n, M_i, j;. In 3D, the arrangement is: Σ_i, j, k=1−n, M_i, j, k. (Note that this is simple enumerative assignment and distinct from Levi-Civita assignment).

Both the electrical power that can be generated and the total isotopic mass that the array can contribute are again, and significantly, in the form of Σ_i(, j, k)=1−n; n_i(, j, k)⁻¹. If a 10-machine array were to be deployed for electrical power generation purposes, each machine would contribute 1/10th of the total power. Should a 10% increase in power output be required of the system, then the total increase demanded from each unit would only be 1/100 (1/n²), viz., 1%, since the demand increases as the inverse square.

For deployment in arrays, the water in the reactors may have e.g., 20% enriched uranium. Therefore, the fuel may be liquid instead of solid. Unlike other techniques involving solids, using liquids may be more economical.

### EXAMPLES

In one example, a nuclear reactor's primary reactor vessel (PRV) is being 3D printed using additive manufacturing techniques.

In another example, a nuclear reactor's PRV is being 3D-printed using additive manufacturing techniques. A metallic alloy or superalloy, a polymer or a fluoropolymer may be used as the printing material. Some examples of superalloys are: MoNiCr, Hastelloy, Inconel, Monel. Some examples of appropriate (fluoro)polymers that satisfy the criteria as described hereabove are: (syndiotactic, isotactic) polypropylene, high-density polypropylene, polyethylene, polyvinylidene difluoride (PVDF), polytetrafluoroethylene (PTFE), ethylene-chlorotrifluoroethylene (ECTFE).

In another example, the piezoelectric effects of certain isomorphs of PVDF known to exhibit piezoelectric properties under appropriate conditions may be employed to effect certain chemistries which may be electrochemical in nature.

In another example, a low-temperature, high-neutron-flux, fluid-fueled nuclear reactor is 3D printed using a single, or a blend of appropriate (fluoro)polymers that satisfy the criteria as described hereabove.

In another example, one type of nuclear reactor, an aqueous homogeneous reactor (AHR), is 3D printed using additive manufacturing techniques.

In another example, an AHR is 3D printed using additive manufacturing techniques using a (fluoro)polymer that satisfy the criteria as described hereabove.

In another example, an AHR is 3D printed using additive manufacturing techniques, using a fluoropolymer such as PVDF, ECTFE, PTFE or binary, ternary or n-ary blends of polymers and/or fluoropolymers, so as to maximize the robustness and long-term performance of the PRV according to the criteria set forth hereabove.

In another example, an AHR, its PRV, its lid, assemblies, sub assemblies or components are 3D printed using additive manufacturing techniques, using a fluoropolymer such as PVDF, containing one or more (or ratios) of its four crystalline phases of PVDF.

In another example, the AHR may be 3D printed using additive manufacturing techniques and may be formed of metal.

In another example, polyimides (PI), polyetherimides (PEI) and other polyimide derivatives as reactor materials may be used to additively manufacture aspects of the reactor, including the primary reactor vessel. Polymers may be used for the reaction vessels and process chemistry vessels: polymers are already robustly resistant to degradation and failure by neutron bombardment, helium embrittlement and gamma-driven polymer degradation/breakdown.

What is claimed is:

1. A nuclear reactor that is created using a polymer.

2. The nuclear reactor of claim 1, wherein the polymer includes a fluoropolymer.

3. The nuclear reactor of claim 1, wherein at least a portion of the nuclear reactor is made of a fluoropolymer.

4. The nuclear reactor of claim 1, comprising a hull, lid and one or more sub-assemblies.

5. The nuclear reactor of claim 1, wherein creating the nuclear reactor includes sintering or other methods of construction.

6. The nuclear reactor of claim 1, wherein creating the nuclear reactor includes 3D printing at least one shape that is spherical, ellipsoidal, spheroidal or pseudo cylindrical.

7. The nuclear reactor of claim 1, wherein a configuration of the reactor is creating using generative design.

8. The nuclear reactor of claim 1, wherein a hull, lid and any sub-assemblies will be 3D printed by an acceptable polymer or fluoropolymer.

9. The nuclear reactor of claim 1, wherein the nuclear reactor is a 3D-printed aqueous homogeneous reactor, wherein a core fluid of the 3D-printed aqueous homogeneous reactor will be agitated/stirred by means of a (fluoro)polymer mixing wand with n-number of blades, the agitation of can statistically improve the probability of neutron-fissile nuclide collision for the purposes of successful fission.

10. The nuclear reactor of claim 1, wherein a lid or hull of the reactor comprises a number of tubes protruding radially at some optimal angle, θ, away from the z-axis, normal to the curved surface of the reactor, which will be a function of the surface area of the reactor given the surface area is a function of the volume of the reactor (4πr²), and which is suitable for transmutation/breeding of any number of isotopes.

11. The nuclear reactor of claim 1, wherein holes in a lid of the reactor are in such a configuration as to permit suction, measurement and return of the liquid fuel, for the purposes of measurement of the properties of said fuel, measurements that include, but are not limited to: temperature, pH, TDS, salinity, osmolarity, osmolality, alpha flux, beta flux, neutron flux, gamma flux, molarity.

12. The nuclear reactor of claim 1, wherein an inner wall at a geographic South Pole of the reactor has a receiving bearing, said bearing may or may not be 3D printed and is of an accommodating shape and geometry that it can receive the tip of the mixing paddle, so as to ensure symmetric stirring.

13. The nuclear reactor of claim 1, wherein a lid and hull of the nuclear reactor are 3D printed using a polymer of the type syndiotactic or isotactic Polypropylene, polyethylene, or any of the types of fluoropolymers that exhibit the aforementioned robustness which may include, but are not limited to: PVDF (or its crystalline heteromorphs), PTFE, ECTFE, or any fluoro-co-polymers, terpolymers or the like.

14. The nuclear reactor of claim 1, wherein hull, lid, assemblies, sub assemblies and any components that may contact the core fissile fluid, aqueous blanket or any breeding or transmuting materials that may be contained within, be 3D printed with a fluoropolymer such as PVDF.

15. The nuclear reactor of claim 1, wherein a pseudo-spherical breeding blanket be 3D-printed using a (fluoro)polymer that meets the stringent criteria set above, intended to behave as neutron-invisible as the reactor hull, and is intended to breed future, virgin fuel in the form of fissile or non-fissile isotopes. Those isotopes include, but are not limited to: ²³³U, ²³⁷Np, ²³⁹Pu, ²⁴¹Pu, ²⁴¹Am, ²⁴²Am.

16. The nuclear reactor of claim 1, wherein the nuclear reactor is operable for self “replicating reactors”, wherein one or more reactors can be configured to breed nuclear fuel for another reactor. This may be implemented in a “Von Neumann Machine” Architecture where autonomous systems are manufacturing and operating reactors, creating a self replicating machine.

17. The nuclear reactor of claim 1, further comprising geometry including heat exchangers built into the walls of the material.

18. The nuclear reactor of claim 1, further comprising use of heat exchangers to heat the main reactor in a “jacketed chemical reactor” configuration.

19. The nuclear reactor of claim 1, the nuclear reactor being made at least partially from polymer using one or more manufacturing methods, such as 3D printing, Roto, molding or injection, molding, or centering.

20. A method, comprising:
forming a first reactor using additive manufacturing;
forming a second reactor using additive manufacturing; and
coupling the first reactor to the second reactor to form an array of reactors.
